(19) United States
(12) Patent Application Publication
(10) Pub. No.: US 2026/0275123 A1
(43) Pub. Date: Sep. 17, 2026

(54) FIRE RETARDANT COMPOSITIONS, SYSTEMS, AND METHODS OF USE THEREOF

(71) Applicant: Barricade International, Inc., Hobe Sound, FL (US)

(72) Inventors: John Bill Bartlett, Juniper, FL (US); Benjamin Walker Bartlett, Port Saint Lucie, FL (US)

(21) Appl. No.: 19/563,313

(22) Filed: Mar. 11, 2026

Related U.S. Application Data
(60) Provisional application No. 63/770,023, filed on Mar. 11, 2025.

(51) Int. Cl. C09D 5/18; C09D 103/00; C09D 191/00

(52) U.S. Cl. CPC C09D 5/18; C09D 103/00; C09D 191/00

(57) ABSTRACT

A fire retardant composition is provided that includes a superabsorbent polymer, starch, and oil. The superabsorbent polymer is present in an amount ranging from about 5 wt.% to about 45 wt.%, the starch is present in an amount ranging from about 2.5 wt.% to about 40 wt.%, and the oil is present in an amount ranging from about 40 wt.% to about 70 wt.%. A fire retardant composition including a concentrate and water is also provided. The concentrate includes a superabsorbent polymer, starch, and oil. The concentrate is present in the fire retardant composition in an amount ranging from about 0.1 wt.% to about 4 wt.%, and the water is present in the fire retardant composition in an amount ranging from about 96 wt.% to about 99.9 wt.%. A fire retardant system including a substrate onto which the fire retardant composition is applied is also contemplated.

### CROSS-REFERENCE TO RELATED APPLICATIONS

The present application claims the benefit of and priority to U.S. Provisional Patent Application No. 63/770,023, filed March 11, 2025, the entire disclosure of which is incorporated by reference herein.

### TECHNICAL FIELD

The subject matter disclosed herein is generally directed to fire retardant compositions. Systems and methods of use that incorporate the fire retardant compositions are also disclosed.

### BACKGROUND

As evidenced from the rapid outbreak and spread of the Los Angeles wildfires in 2025, resulting in the loss of life and the destruction of thousands of acres of land, building structures, and vehicles, the ability to contain and control the spread of fires is critical to saving lives and saving property from permanent damage. Typical fire retardant compositions that can be sprayed on a fire directly or sprayed on a substrate to help stop the spread of a fire are generally emulsion-based. A problem with emulsion-based compositions is that such compositions have a limited shelf-life due to the settling of the various components in the emulsion. While surfactants can be added to the emulsion-based compositions to prevent settling, these are often expensive and can be unfriendly to the environment. Stabilizers, such as fumed silica, can also be used, but these are also expensive. Further, many fire retardant compositions are often heavy and difficult to ship, which also adds to the overall cost.

As such, a need currently exists for a fire retardant composition that solves these problems and can be shipped in ready-to-use format.

### SUMMARY

Aspects and advantages of embodiments of the present disclosure will be set forth in part in the following description, or can be learned from the description, or can be learned through practice of the embodiments.

In one aspect of the present disclosure, a fire retardant composition is contemplated that includes a superabsorbent polymer, wherein the superabsorbent polymer is present in an amount ranging from about 5 wt.% to about 45 wt.% based on the total weight of the fire retardant composition; a starch, wherein the starch is present in an amount ranging from about 2.5 wt.% to about 40 wt.% based on the total weight of the fire retardant composition; and an oil, wherein the oil is present in an amount ranging from about 40 wt.% to about 70 wt.% based on the total weight of the fire retardant composition.

In another embodiment, the fire retardant composition can have a Brookfield viscosity ranging from about 1800 centipoise to about 3200 centipoise as determined at 20°C.

In yet another embodiment, the superabsorbent polymer can have a mesh size ranging from about 0.001 micrometers to about 500 micrometers.

In still another embodiment, the starch can include a corn starch, a potato starch, a tapioca starch, a rice starch, or a combination thereof. For example, the starch can include corn starch, such as high amylose corn starch.

In one more embodiment, the oil can include a vegetable oil, wherein the vegetable oil includes rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof. For example, the oil can include a modified rapeseed oil having an erucic acid content of less than about 2 wt.%.

In an additional embodiment, the oil can have a smoke point ranging from about 180°C to about 250°C.

In another aspect of the present disclosure, a fire retardant composition is contemplated that includes a concentrate and water. The concentrate includes a superabsorbent polymer, a starch, and an oil. The concentrate is present in the fire retardant composition in an amount ranging from about 0.1 wt.% to about 4 wt.% based on the total weight of the fire retardant composition, and the water is present in the fire retardant composition in an amount ranging from about 96 wt.% to about 99.9 wt.% based on the total weight of the fire retardant composition.

In one embodiment, the fire retardant composition can have a Brookfield viscosity ranging from about 20,000 centipoise to about 300,000 centipoise as determined at 20°C.

In another embodiment, the superabsorbent polymer can be present in an amount ranging from about 5 wt.% to about 45 wt.% based on the total weight of the concentrate, wherein the starch is present in an amount ranging from about 1.0 wt.% to about 40 wt.% based on the total weight of the concentrate, and wherein the oil can be present in an amount ranging from about 40 wt.% to about 70 wt.% based on the total weight of the concentrate.

In yet another embodiment, the starch can include a corn starch, a potato starch, a tapioca starch, a rice starch, or a combination thereof.

In still another embodiment, the oil can include a vegetable oil, wherein the vegetable oil includes rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof.

In one more aspect of the present disclosure, a fire retardant system is contemplated. The fire retardant system includes a substrate and a fire retardant composition. The fire retardant composition includes a superabsorbent polymer, wherein the superabsorbent polymer is present in an amount ranging from about 5 wt.% to about 45 wt.% based on the total weight of the fire retardant composition; a starch, wherein the starch is present in an amount ranging from about 2.5 wt.% to about 40 wt.% based on the total weight of the fire retardant composition; and an oil, wherein the oil is present in an amount ranging from about 40 wt.% to about 70 wt.% based on the total weight of the fire retardant composition.

In one embodiment, the superabsorbent polymer can have a mesh size ranging from about 0.001 micrometers to about 500 micrometers.

In another embodiment, the starch can include a corn starch, a potato starch, a tapioca starch, a rice starch, or a combination thereof. For example, the starch can be corn starch.

In yet another embodiment, the oil can be a vegetable oil, wherein the vegetable oil includes rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof. Further, the oil can have a smoke point ranging from about 180°C to about 250°C.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

A full and enabling disclosure of the present disclosure to one skilled in the art, including the best mode thereof, is set forth more particularly in the remainder of the specification, including reference to the accompanying figures, in which:

FIG. 1 illustrates a simple home system for application of the fire retardant composition contemplated the present disclosure, which includes a nozzle in combination with a reservoir in the form of a pressure supply cylinder that is coupled to a tap water outlet at a building structure;

FIG. 2 is similar to FIG. 1 but illustrates the application of the fire retardant composition with a system that includes a backpack for the reservoir, where the reservoir is coupled to a fixed pressure water source;

FIG. 3 is another embodiment illustrating that the concentrate and the water used to form the final solution of the fire retardant composition of the present disclosure can be contained in two segregated portions of a backpack and applied by means of a hand pump, where the hand pump can pressurize the water and the concentrate separately followed by delivery from a nozzle;

FIG. 4 is one more embodiment illustrating a system where the concentrate and the water can be combined in a single reservoir inside, for example, a fire truck prior to application of the fire retardant composition to a structure;

FIG. 5 illustrates a substrate on which the fire retardant composition has been applied; and

FIG. 6 illustrates the application of the substrate of FIG. 5 to a structure.

Repeat use of reference characters in the present specification and drawings is intended to represent the same or analogous features or elements of the present disclosure.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present disclosure. Any of the features, components, or details of any of the arrangements or embodiments disclosed in this application are interchangeably combinable with any other features, components, or details of any of the arrangements or embodiments disclosed herein to form new arrangements and embodiments.

Generally speaking, the present disclosure is directed to a fire retardant composition is provided that includes a superabsorbent polymer, a starch, and an oil. The superabsorbent polymer is present in an amount ranging from about 5 wt.% to about 45 wt.%, the starch is present in an amount ranging from about 2.5 wt.% to about 40 wt.%, and the oil is present in an amount ranging from about 40 wt.% to about 70 wt.%, based on the total weight of the fire retardant composition. A fire retardant composition including a concentrate and water is also provided. The concentrate includes a superabsorbent polymer, starch, and oil. The concentrate is present in the fire retardant composition in an amount ranging from about 0.1 wt.% to about 4 wt.%, and the water is present in the fire retardant composition in an amount ranging from about 96 wt.% to about 99.9 wt.%, based on the total weight of the fire retardant composition. A fire retardant system including a substrate onto which the fire retardant composition is applied is also contemplated. The present inventors have found that the composition contemplated by the present disclosure is effective in preventing the spread of fire that is free of fumed silica, surfactants, and/or emulsifiers such as SPAN 80, resulting in a more environmentally friendly yet effective composition.

Further, without intending to be limited by any particular theory, the present inventors have found that the specific components and weight percentages utilized for the various components results in a fire retardant composition that has a suitable viscosity for adhering to surfaces without running but that can also be sprayed or otherwise delivered to surfaces easily without clogging of any hoses, nozzles, or sprayers used to deliver the fire retardant composition. The various components of the fire retardant composition and the various uses of the fire retardant composition are discussed in detail below.

### Concentrate

The present disclosure is directed to a fire retardant composition that can be maintained in a concentrate form until it is ready for use, at which time the concentrate can be combined with water to create a solution that can be sprayed or otherwise delivered onto a surface, such as siding on a house, vegetation or ground cover, a vehicle, a roof, or generally any building structure or surface that could be at risk for catching fire. The solution can also be coated, sprayed, dipped, or otherwise applied onto any substrate, including but not limited to fabrics, hoses, etc.,, and the substrate can be placed or draped over various structures (e.g., power lines, fences, walls, buildings, roads, rooves, etc.) to prevent the spread of a fire and/or to create a containment border for the fire.

The various components of the fire retardant composition, in concentrate form, can include a superabsorbent polymer, a starch, and an oil, each of which are discussed in more detail below. In solution form, the fire retardant composition can additionally include water. The concentrate form of the fire retardant composition can have a Brookfield viscosity ranging from about 1800 centipoise to about 3200 centipoise, such as from about 1900 centipoise to about 3100 centipoise, such as from about 2000 centipoise to about 3000 centipoise, or any range or value therebetween, as determined at 20°C. Meanwhile, the solution form of the fire retardant composition can range from about 20,000 centipoise to about 300,000 centipoise, such as from about 25,000 centipoise to about 150,000 centipoise, such as from about 30,000 centipoise to about 75,000 centipoise, or any range or value therebetween, as determined at 20°C after water has been added to the concentrate.

### I. Superabsorbent Polymer (SAP)

The fire retardant composition of the present disclosure includes a SAP. SAPs are water-absorbing hydrophilic homopolymers or copolymers that are generally capable of absorbing and bonding with water molecules to retain large amounts of liquid relative to their own mass. In some embodiments, the SAP can be crosslinked. In some embodiments, the SAP contemplated by the present disclosure can be a crosslinked polyacrylate, a cross-linked polyacrylamide, a cellulose-acrylonitrile graft copolymer, a starch-acrylonitrile graft copolymer, a cross-linked maleic anhydride copolymer, or a combination thereof.

The mesh or grind size of the SAP utilized in the fire retardant compositions of the present disclosure can range from about 0.001 micrometers to about 500 micrometers, such as from about 0.01 micrometers to about 250 micrometers, such as from about 0.1 micrometers to about 100 micrometers, or any ranges or value therebetween. In some embodiments, such as when a small garden hose is utilized to deliver the composition to a surface, a smaller mesh size is contemplated, while a larger mesh size can be used when, for example, when a pressure washer or fire truck hose is being used to deliver the composition to a surface.

The SAP can be present in the concentrate form of the fire retardant compositions of the present disclosure in an amount ranging from about 5 wt.% to about 45 wt.%, such as from about 10 wt.% to about 40 wt.%, such as from about 15 wt.% to about 35 wt.%, or any range or value therebetween, based on the total weight of the concentrate, prior to adding water.

### II. Starch

The fire retardant composition of the present disclosure also includes a starch. Starch is a complex carbohydrate that includes two types of polysaccharide molecules, amylose, a mostly linear and flexible polymer of D-anhydroglucose units that are linked by alpha-1,4-D-glucosidic bonds, and amylopectin, a branched polymer of amylose chains that are linked by alpha-1,6-D-glucosidic bonds. Thus, the linear fraction of starch is known as amylose and the branched fraction amylopectin. Starches from different sources (e.g., corn, potato, tapioca, and rice, etc.) are characterized by different relative proportions of the amylose and amylopectin components. Some plant species have been genetically developed which are characterized by a large preponderance of one fraction over the other. For instance, certain varieties of corn, which normally contain about 22 to 28% amylose, have been developed which yield starch composed of over 40% amylose. These hybrid varieties have been referred to as high amylose or amylomaize.

High amylose corn hybrids were developed in order to naturally provide starches of high amylose content and have been available commercially since about 1963. Suitable starches useful herein are any starches with an amylose content of at least about 20% by weight, such as from about 22% by weight to about 70% by weight, such as from about 24% by weight to about 65% by weight, such as from about 26% by weight to about 60% by weight. While high amylose corn starch (e.g., an amylose content of greater than about 40%) has been especially suitable, other starches which are useful include those derived from any plant species which produces or can be made to produce a high amylose content starch, e.g., corn, peas, barley, wheat, potato, tapioca and rice, and it should also be understood that it is not required that the amylose content be greater than 40%.

The starch material useful in this invention also may include high amylose flour, where the starch component of the flour contains at least 40% by weight of amylose. The term starch as used throughout this application is intended to include flour and when the high amylose content of flour is referred to throughout the application and claims, it is understood to refer to the amylose content of the starch component of the flour (e.g., 40% by weight of amylose based on the amount of starch in the flour). Such flour typically comprises protein (about 8 to 13% by weight), lipids (about 2 to 3% by weight) and starches (about 85 to 90% by weight) which include the specified high amylose content.

The starch can be present in the concentrate form of the fire retardant compositions of the present disclosure in an amount ranging from about 1.0 wt.% to about 40 wt.%, such as from about 5 wt.% to about 35 wt.%, such as from about 10 wt.% to about 30 wt.%, or any range or value therebetween, based on the total weight of the concentrate, prior to adding water.

### III. Oil

Additionally, the fire retardant composition of the present disclosure includes an oil. In some embodiments, the oil can be a vegetable oil, although it is to be understood that any other suitable oil is contemplated by the present disclosure. The term “vegetable oil” generally refers to oil derived from plant seeds or nuts. Vegetable oils are typically “long-chain triglycerides” (LCTs), formed when three fatty acids (usually 14 to 22 carbons in length, with unsaturated bonds in varying numbers and locations, depending on the source of the oil) form ester bonds with the three hydroxyl groups on glycerol. In certain embodiments, vegetable oils of highly purified grade (also called “super refined”) can be used to ensure safety and stability of the concentrate of the fire retardant composition. In certain embodiments, hydrogenated vegetable oils, which are produced by controlled hydrogenation of the vegetable oil, may be used.

Further, the oil can have a smoke point ranging from about 180°C to about 250°C, such as from about 190°C to about 240°C, such as from about 200°C to about 230°C, or any range or value therebetween.

Exemplary vegetable oils include, but are not limited, to rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof. Hydrogenated and/or or partially hydrogenated forms of these oils may also be used. Further, in one embodiment, the oil can be modified to reduce its acid content. For example, canola oil can be used, which is a modified version of rapeseed oil that contains less than about 2 wt.% of erucic acid, such as less than about 1.5 wt.%, such as less than about 1 wt.% of erucic acid.

The oil can be present in the concentrate form of the fire retardant compositions of the present disclosure in an amount ranging from about 40 wt.% to about 70 wt.%, such as from about 45 wt.% to about 65 wt.%, such as from about 50 wt.% to about 60 wt.%, or any range or value therebetween, based on the total weight of the concentrate, prior to adding water.

Further, in some embodiments, it should be understood that the oil can be maintained separately from the SAP and starch and can be added at the desired time of use, but the combination of the SAP, starch, and oil is still referred to as the concentrate from of the fire retardant compositions of the present disclosure. In such cases, the shelf life of the concentrate can be increased.

### Final Solution

Once the concentrate has been made, it can be stored until ready for use. At the time of use, the concentrate can be combined with water to form a final solution of the fire retardant composition. The water can be present in the final solution of the fire retardant composition in an amount ranging from about 96 wt.% to about 99.9 wt.%, such as from about 96.5 wt.% to about 99.8 wt.%, such as from about 97 wt.% to about 99.5 wt.%, or any range or value therebetween, based on the total weight of the fire retardant composition. Meanwhile, the concentrate as described above can be present in the final solution of the fire retardant composition in an amount ranging from about 0.1 wt.% to about 4 wt.%, such as from about 0.2 wt.% to about 3.5 wt.%, such as from about 0.5 wt.% to about 3 wt.%, or any range or value therebetween, based on the total weight of the fire retardant composition.

### Use of the Fire Retardant Composition

Referring now to the figures, various applications and use of the fire retardant composition contemplated by the present disclosure are described.

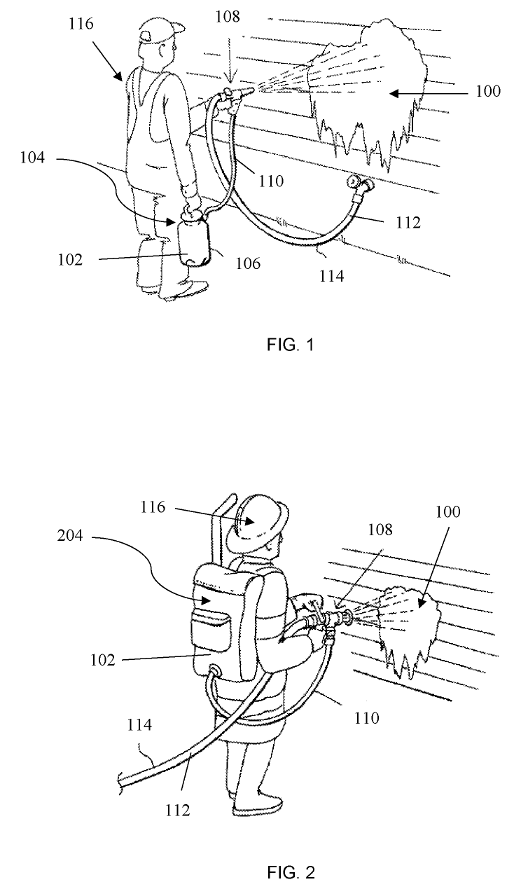

FIG. 1 illustrates a simple home system for application of the fire retardant composition 100 contemplated the present disclosure. The concentrate 102 of the fire retardant composition 100 can be stored in a sprayer 104 that serves as a reservoir 106 for the concentrate 102. The reservoir 106 can be coupled to a nozzle 108 via a hose 110, and water 112 can be introduced to the system via a water hose 114, which can be coupled to a water source at a tap outlet at a building structure. The concentrate 102 and the water 112 can mix at the nozzle 108 so that the resulting final solution of the fire retardant composition 100 can be sprayed or delivered as desired. However, it is also to be understood that the water 112 can alternatively be added to the concentrate 102 in the reservoir 106 or in any other container and then this solution can be mixed, after which the resulting final solution of the fire retardant composition 100 can be sprayed or otherwise delivered onto any surface, such as a building structure or any other structure or object by a person 116.

FIG. 2 is similar to FIG. 1 but illustrates the application of the fire retardant composition 100 with a system that includes a backpack sprayer 204 for storing the concentrate 102, where the backpack sprayer 204 can be coupled to a nozzle 108 via a hose 110, and water 112 can be introduced to the system via a water house 114, which can be coupled to a fixed pressure water source. The concentrate 102 and the water 112 can mix at the nozzle 108 so that the resulting final solution of the fire retardant composition 100 can be sprayed or delivered as desired. However, it is also to be understood that the water 112 can alternatively be added to the concentrate 102 in the reservoir 106 or in any other container and then this solution can be mixed, after which the resulting final solution of the fire retardant composition 100 can be sprayed or otherwise delivered onto any surface, such as a building structure or any other structure or object by a person 116.

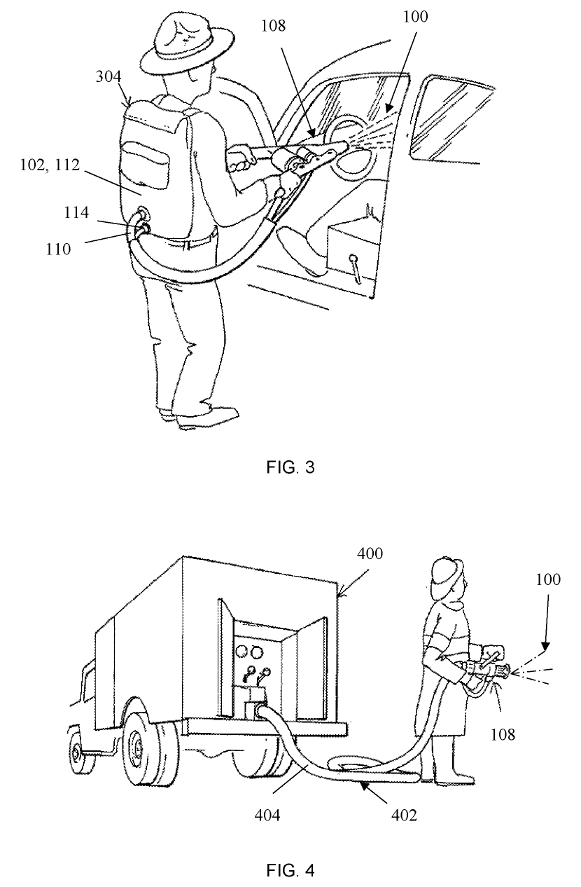

FIG. 3 is another embodiment illustrating that the concentrate 102 and the water 112 used to form the final solution of the fire retardant composition 100 of the present disclosure can be contained in two segregated portions of a backpack 304 and applied by means of a hand pump at nozzle 108, where the hand pump can pressurize the water and the concentrate separately followed by delivery from the nozzle 108. However, it is also to be understood that the water 112 can alternatively be added to the concentrate 102 in the reservoir 106 in a single, unsegregated portion or in any other container and then this solution can be mixed, after which the resulting final solution of the fire retardant composition 100 can be sprayed or otherwise delivered onto any surface, such as a building structure or any other structure or object by a person 116.

FIG. 4 is one more embodiment illustrating a system where the concentrate 102 and the water 112 can be combined and mixed in a single reservoir inside, for example, a fire truck 400 prior to application of the fire retardant composition 100 to a structure, where a blend 404 of the concentrate 102 and the water 112 travels from the truck 400 via hose 402 for delivery from the nozzle 108.

It is also to be understood that other uses for the fire retardant composition 100 of the present disclosure are contemplated, including, but not limited to, delivery of the fire retardant composition 100 from aircraft such as airplanes, sea planes, helicopters, drones, etc.

Additionally, the fire retardant composition 100 can be used as a pre-treatment using a substrate that can be in the form of a soaker hose (a hose containing small openings). The soaker hose can be utilized in conjunction with a timer, which can be battery-operated. The soaker hose can be hooked up to a water supply and the exterior of the hose can be coated, sprayed, etc. with the fire retardant composition 100 to pre-treat an area that is susceptible to fire. Optionally, the soaker hose can be tacked to a ridge line of a house to provide fire protection. The timer can be used to begin the process of the fire retardant composition 100 being activated in the presence of water to prevent a fire from spreading.

Regardless of the particular system used to deliver or spray the fire retardant composition 100 to a surface, it is to be understood that the concentrate 102, which can include the SAP and starch, can be shipped to the end user, after which time the oil and water can be combined with the concentrate 102 to form the blend 404 that is ultimately delivered to the surface as the final solution of the fire retardant composition 100. However, it is also to be understood that the concentrate 102 can include the oil as well, and the water can be added at the time of use to form the final solution of the fire retardant composition 100. Additionally, it should be understood that the fire retardant composition 100 can be sprayed on, for example, a surface of a road to trap dust and other particles that may be left behind after a fire, which can help trap hazardous and carcinogenic materials from being carried off by the wind during cleanup. The coated dust and particles that are trapped by the fire retardant composition 100 can then be cleared away with shovels, bulldozers, and other equipment without the risk of such hazardous particles polluting or contaminating the air.

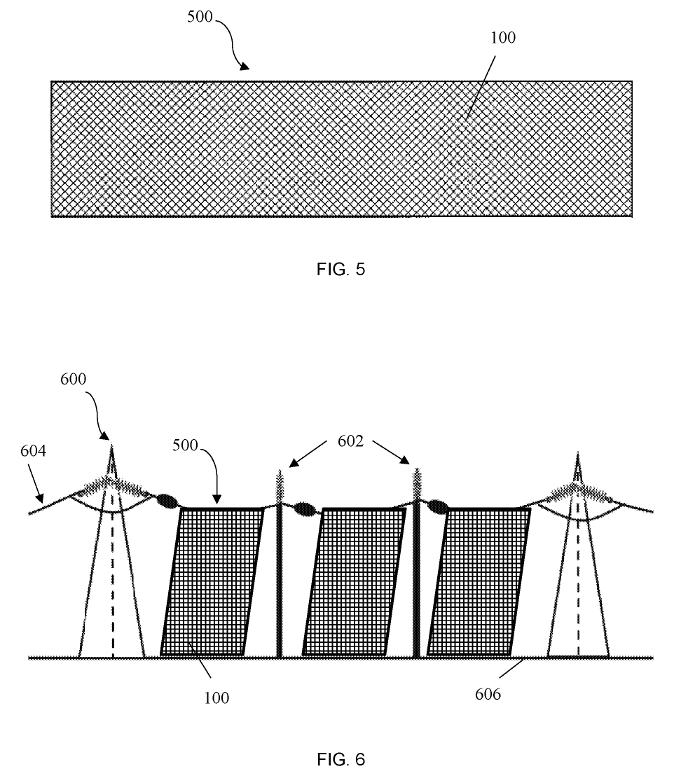

FIG. 5 illustrates another embodiment contemplated by the present disclosure in which the fire retardant composition 100 has been applied to a substrate 500. Any suitable material can be used for the substrate 500, but, in some embodiments, the material can include a woven, non-woven, spun, or perforated fabric. The substrate can be formed from various materials, including, but not limited to a polyester, a polypropylene, or a combination thereof. Other examples include soil barrier materials, artificial turf, terry cloth, and the like. In some embodiments, the material can be biodegradable or compostable. In other embodiments, the material can be an artificial turf, an outdoor carpet, terry cloth, landscape material for weed control, a tarpaulin, a shade cloth, etc. Further, the substrate can be in the form of a mesh or otherwise have small openings that allow for the fire retardant composition 100 of the present disclosure to coat the substrate 500.

The substrate 500 can be coated with the fire retardant composition 100 by spraying, coating, dipping, soaking, rolling, painting, or any other suitable means applying the fire retardant composition 100 to the substrate. For instance, a tube containing holes may be filled with the fire retardant composition 100, and the tube can be rolled over the substrate 500 to allow the fire retardant composition 100 to seep out of the holes and onto the substrate 500 along its entire surface area.

After the fire retardant composition 100 has been applied to the substrate 500, the substrate 500 can be applied to or hung from any surface to create a fire barrier. However, it is also to be understood that the fire retardant composition 100 can be applied to the substrate 500 after the substrate 500 is applied to or hung from any surface to create a fire barrier.

Referring to FIG. 6, on example of an application of a substrate 500 is illustrated. Specifically, the substrate 500 containing the fire retardant composition 100 (which can be applied prior to or after placement of the substrate 500) can be positioned along a power line system 600. For instance, the substrate 500 can be draped across power lines 604 disposed between utility poles 602 or any other vertically-extending objects (e.g., posts, tree trunks, towers, etc.) to create a barrier to present the spread of fire at the point where the substrate 500 can contact the surface of ground 606. For instance, if power lines 604 and utility poles 602 are not available, portable structures can be positioned to suspend one or more cables across and over which the substrate 500 can be draped. Further, hooks, ties, or any other suitable fastening mechanism can be used to hang or drape the substrate 500 over the power lines 604, cables, etc. In addition, the substrate 500 can be tied or pegged to the ground to keep it from billowing during wind gusts. Additionally or alternatively, the substrate 500 can be held in place via a soaker hose or other water hose on the ground.

More specifically, the substrate 500, which can be coated with the fire retardant composition 100, and then

The use of such a substrate 500 can be beneficial on sloped terrain, where fires can spread rapidly.

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the present disclosure, but instead as merely intended to highlight alternative or additional features that may or may not be utilized in a particular embodiment of the present disclosure. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments. For instance, when a plurality of ranges are provided, any combination of a minimum value and a maximum value described in the plurality of ranges are contemplated by the present disclosure. For example, if ranges of ‘from about 20% to about 80%’ and ‘from about 30% to about 70%’ are described, a range of ‘from about 20% to about 70%’ or a range of ‘from about 30% to about 80%’ are also contemplated by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article ‘a’ or ‘an’ does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ‘at least one’ and ‘one or more’ to introduce claim recitations. However, the use of such phrases should not be construed to imply that the introduction of a claim recitation by the indefinite articles ‘a’ or ‘an’ limits any particular claim containing such introduced claim recitation to embodiments containing only one such recitation, even when the same claim includes the introductory phrases ‘one or more” or ‘at least one’ and indefinite articles such as ‘a’ or ‘an’ (e.g., ‘a’ and/or ‘an’ should typically be interpreted to mean ‘at least one’ or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of ‘two recitations,’ without other modifiers, typically means at least two recitations, or two or more recitations). Furthermore, in those instances where a convention analogous to ‘at least one of A, B, and C, etc.’ is used, in general such a construction is intended in the sense one having skill in the art would understand the convention (e.g., ‘a system having at least one of A, B, and C’ would include but not be limited to systems that have A alone, B alone, C alone, A and B together, A and C together, B and C together, and/or A, B, and C together, etc.). In those instances where a convention analogous to ‘at least one of A, B, or C, etc.’ is used, in general such a construction is intended in the sense one having skill in the art would understand the convention (e.g., ‘a system having at least one of A, B, or C’ would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase ‘A or B’ will be understood to include the possibilities of ‘A’ or ‘B’ or ‘A and B.’

All numbers expressing quantities of ingredients, reaction conditions, and so forth used in the specification are to be understood as being modified in all instances by the terms ‘about,’ ‘approximately,’ or ‘generally.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches. As used herein, the terms ‘about,’ ‘approximately,’ or ‘generally,’ when used to modify a value, indicate that the value can be raised or lowered by 5% and remain within the disclosed embodiment.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A fire retardant composition comprising:
a superabsorbent polymer, wherein the superabsorbent polymer is present in an amount ranging from about 5 wt.% to about 45 wt.% based on the total weight of the fire retardant composition;
a starch, wherein the starch is present in an amount ranging from about 1.0 wt.% to about 40 wt.% based on the total weight of the fire retardant composition; and
an oil, wherein the oil is present in an amount ranging from about 40 wt.% to about 70 wt.% based on the total weight of the fire retardant composition.

2. The fire retardant composition of claim 1, wherein the fire retardant composition has a Brookfield viscosity ranging from about 1800 centipoise to about 3200 centipoise as determined at 20°C.

3. The fire retardant composition of claim 1, wherein the superabsorbent polymer has a mesh size ranging from about 0.001 micrometers to about 500 micrometers.

4. The fire retardant composition of claim 1, wherein the starch comprises a corn starch, a potato starch, a tapioca starch, a rice starch, or a combination thereof.

5. The fire retardant composition of claim 4, wherein the starch comprises corn starch.

6. The fire retardant composition of claim 5, wherein the corn starch is a high amylose corn starch.

7. The fire retardant composition of claim 1, wherein the oil comprises a vegetable oil, wherein the vegetable oil comprises rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof.

8. The fire retardant composition of claim 7, wherein the oil comprises a modified rapeseed oil having an erucic acid content of less than about 2 wt.%.

9. The fire retardant composition of claim 1, wherein the oil has a smoke point ranging from about 180°C to about 250°C.

10. A fire retardant composition comprising:
a concentrate comprising:
a superabsorbent polymer;
a starch; and
an oil; and
water;
wherein the concentrate is present in the fire retardant composition in an amount ranging from about 0.1 wt.% to about 4 wt.% based on the total weight of the fire retardant composition, and wherein the water is present in the fire retardant composition in an amount ranging from about 96 wt.% to about 99.9 wt.% based on the total weight of the fire retardant composition.

11. The fire retardant composition of claim 10, wherein the fire retardant composition has a Brookfield viscosity ranging from about 20,000 centipoise to about 300,000 centipoise as determined at 20°C.

12. The fire retardant composition of claim 10, wherein the superabsorbent polymer is present in an amount ranging from about 5 wt.% to about 45 wt.% based on the total weight of the concentrate, wherein the starch is present in an amount ranging from about 2.5 wt.% to about 40 wt.% based on the total weight of the concentrate, and wherein the oil is present in an amount ranging from about 40 wt.% to about 70 wt.% based on the total weight of the concentrate.

13. The fire retardant composition of claim 10, wherein the starch comprises a corn starch, a potato starch, a tapioca starch, a rice starch, or a combination thereof.

14. The fire retardant composition of claim 10, wherein the oil comprises a vegetable oil, wherein the vegetable oil comprises rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof.

15. A fire retardant system comprising:
a substrate; and
a fire retardant composition, the fire retardant composition comprising:
a superabsorbent polymer, wherein the superabsorbent polymer is present in an amount ranging from about 5 wt.% to about 45 wt.% based on the total weight of the fire retardant composition;
a starch, wherein the starch is present in an amount ranging from about 2.5 wt.% to about 40 wt.% based on the total weight of the fire retardant composition; and
an oil, wherein the oil is present in an amount ranging from about 40 wt.% to about 70 wt.% based on the total weight of the fire retardant composition.

16. The fire retardant system of claim 15, wherein the superabsorbent polymer has a mesh size ranging from about 0.001 micrometers to about 500 micrometers.

17. The fire retardant system of claim 15, wherein the starch comprises a corn starch, a potato starch, a tapioca starch, a rice starch, or a combination thereof.

18. The fire retardant system of claim 17, wherein the starch comprises corn starch.

19. The fire retardant system of claim 15, wherein the oil comprises a vegetable oil, wherein the vegetable oil comprises rapeseed oil, almond oil, babassu oil, black currant seed oil, borage oil, castor oil, coconut oil, corn oil, cottonseed oil, olive oil, peanut oil, palm oil, palm kernel oil, safflower oil, soybean oil, sunflower oil, sesame oil, or a combination thereof.

20. The fire retardant system of claim 15, wherein the oil has a smoke point ranging from about 180°C to about 250°C.
